(19) United States
(12) Patent Application Publication
(10) Pub. No.: US 2021/0320866 A1
(43) Pub. Date: Oct. 14, 2021

(54) FLOW CONTROL TECHNOLOGIES

(71) Applicant: Intel Corporation, Santa Clara, CA (US)

(72) Inventors: Yanfang LE, Madison, WI (US); Junggun LEE, Los Altos, CA (US); Jeremias BLENDIN, Santa Cruz, CA (US); Grzegorz JERECZEK, Gdansk (PL); Georgios NIKOLAIDIS, Mountain View, CA (US)

(21) Appl. No.: 17/359,244

(22) Filed: Jun. 25, 2021

Related U.S. Application Data
(63) Continuation-in-part of application No. 16/878,466, filed on May 19, 2020.
(60) Provisional application No. 63/165,036, filed on Mar. 23, 2021.
(60) Provisional application No. 62/967,003, filed on Jan. 28, 2020.

(51) Int. Cl. H04L 12/801; H04L 12/931; H04L 12/851; H04L 12/861

(52) U.S. Cl. CPC H04L 47/12; H04L 47/11; H04L 49/90; H04L 49/351; H04L 47/2441; H04L 49/50

(57) ABSTRACT

Examples described herein relate to a switch that is to receive a message identifying congestion in a second switch; drop the message; generate a pause frame; and cause transmission of the pause frame to at least one sender of packets to a congested queue in the second switch. In some examples, the message includes one or more of: a destination IP address, Differentiated Services Code Point (DSCP) value, or pause duration for the congested queue. In some examples, the DSCP value is to identify a traffic class of the congested queue. In some examples, the pause frame is consistent with Priority Flow Control (PFC) of IEEE 802.1Qbb (2011). In some examples, the switch is to: store, from the message identifying congestion in the second switch, congestion information associated with the congested queue comprising one or more of: destination internet protocol (IP) address, Differentiated Services Code Point (DSCP) value, or pause end time of the congested queue.

### RELATED APPLICATIONS

The present application claims the benefit of a priority date of U.S. provisional patent application Ser. No. 63/165,036, filed Mar. 23, 2021, the entire disclosure of which is incorporated herein by reference.

This application is a continuation-in-part of U.S. patent application Ser. No. 16/878,466, filed May 19, 2020 (AC7344-US), which claims the benefit of a priority date of U.S. provisional patent application Ser. No. 62/967,003, filed Jan. 28, 2020 (AC7344-Z).

### BACKGROUND

Data centers provide vast processing, storage, and networking resources to users. For example, automobiles, smart phones, laptops, tablet computers, or internet of things (IoT) devices can leverage data centers to perform data analysis, data storage, or data retrieval. Data centers are typically connected together using high speed networking devices such as network interfaces, switches, or routers.

End-to-end (E2E) congestion control is deployed to detect network congestion and react to congestion by lowering the per-flow or per-connection transmission bytes or windows. Priority Flow Control (PFC) is a standard network flow control solution described in IEEE standard 802.1Qbb-2011, which is part of the framework for the IEEE 802.1 Data Center Bridging (DCB) interface. PFC enables flow control over a unified 802.3 Ethernet media interface, or fabric, for local area network (LAN) and storage area network (SAN) technologies. PFC is intended to eliminate packet loss due to congestion on a network link. This allows loss-sensitive protocols, such as Fibre Channel over Ethernet (FCoE), to coexist with traditional loss-insensitive protocols over the same unified fabric. PFC avoids congestion packet drops but can incur side effects such as PFC storm, deadlock, and Head-of-Line blocking in fabric links, which can lower network fabric bandwidth. In some cases, E2E congestion control is too slow to detect and react to congestion in sub-round trip time (RTT).

### BRIEF DESCRIPTION OF THE DRAWINGS

FIG. 1 depicts an example system.

FIG. 2 depicts an example system to identify congestion and generate SFC at a switch.

FIG. 3 depicts an example manner of allocating queues for packet egress in a source network interface device.

FIG. 4 depicts an example of reallocation of flows.

FIGS. 5A-5D depict example processes.

FIG. 6 depicts an example network interface device.

FIG. 7 depicts an example switch.

FIG. 8 depicts a system.

### DETAILED DESCRIPTION

A switch before an endpoint receiver device can detect congestion in a queue and generate a source flow control (SFC) signal and send the SFC signal in one or more packets to a sender of packets of a flow that caused the congestion or are associated with congestion in the queue. In some examples, the switch is a destination or last hop before an endpoint receiver device, but can be several hops before an endpoint receiver device. In some cases, the destination switch can attempt to reduce queue build-up and packet drops in response at least to incast network congestion. With incast, multiple senders attempt to send packets to a same destination at the same or overlapping times, leading to a very rapid increase in network traffic at a network device such as a switch. A tuple of destination IP and DSCP codepoint can pinpoint congestion location at one or more of: a switch device, egress port number, or congested queue identifier. For example, a 6-bit field Differentiated Services Code Point (DSCP) and destination IP address can identify which of 64 queues is congested at a destination switch. DSCP can be other numbers of bits.

A source switch can be a first switch in a datacenter that receives a packet prior to forwarding the packet to a server or another switch, such as a first hop switch in a data center, or other switch. Upon receiving an SFC from a congested switch, the source switch can drop an SFC and generate and send a PFC frame to the sender network interface device to cause pause sending packets of one or more flows to the congested queue in the destination switch. The destination switch and/or source switch can be a top of rack (ToR) switch. In response to receiving a PFC frame, transmission by at least one source of packets of at least one flow can be paused at the sender network interface controller (NIC) and/or software stack. Accordingly, some systems can extend PFC (e.g., layer 2 (L2) hop-by-hop flow control) to datacenter edge-to-edge flow control.

SFC may convey congestion information from a congested switch to senders of traffic to the congested switch. In some embodiments, an SFC signal can carry a pause duration and/or pause end time that represents an amount of time to drain the congested queue down to a pre-configured target queue depth. SFC can provide edge-to-edge signaling of congestion. Queues can be paused based on receipt and content of SFC frames by transmitting PFC frames that include the pause time for one or more 8 priorities specified in the PFC standard. Hence, the priority to be paused would be directly specified in a PFC frame.

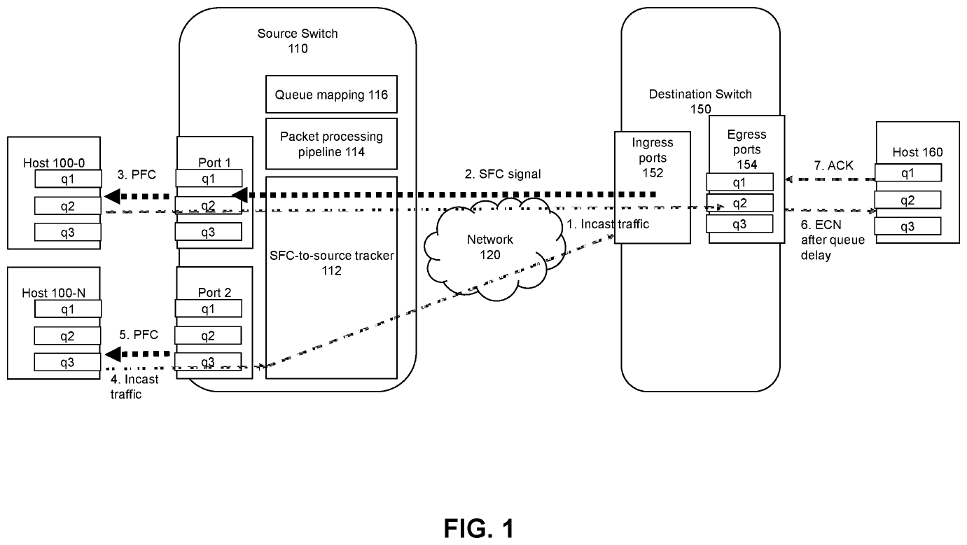

FIG. 1 depicts an example system. Source switch 110 can be a first hop in a datacenter, local area network (LAN), or wide area network (WAN) that receives one or more packets to be forwarded to the receiver host device 160. Destination switch 150 can be a last hop or network device that sends packets to receiver host device 160. Source switch 110 and/or destination switch 150 can be a top of rack (ToR) switch, middle of rack switch, or end of row (EoR) switch. In response to detection of congestion at a queue q2 associated with egress ports 154 of destination switch 150, switch 150 can send an SFC signal to source switch 110. Congestion can be detected based on one or more of: a queue level equaling or exceeding a threshold level and/or a rate of change of queue occupancy of one or more of queues q1 to q3. SFC can be used by source switch 110 to reduce the transmission (TX) rate or pause transmission at host 100-0 to at least congested queue q2, and potentially one or more other queues. The SFC signal can convey one or more of: IP address of sender network interface device, IP address of congested switch, IP address of destination network interface device, Differentiated Services Code Point (DSCP) (e.g., identifier of congested queue), pause duration (to be applied against a reference start time), or remote direct memory access (RDMA) queue pair (QP) number or other transport protocol endpoint identifier (e.g., Transmission Control Protocol (TCP) port, or others). Source flow control (SFC) signaling can be conveyed using L2 (e.g., Ethernet) or L3 (e.g., IP) protocol communications, in some examples. SFC is sent using L3 protocol and can be forwarded multiple hops. SFC packet is compatible with L3 routing.

Source switch 110 can receive the SFC signal and determine a source flow or queue to request to pause transmission. Source switch 110 can receive a mapping 116 of congested queue-to-sender network interface device queue priority level from a control plane, orchestrator, or administrator. Source switch 110 can generate a PFC signal based on content of the SFC signal and a mapping of congested queue-to-sender network interface device queue priority level. Within an Ethernet frame, PFC can include one or more of: PFC priority level (converted from DSCP value), pause duration (converted at source switch 110 according to link speed following the PFC standard).

Source switch 110 can transmit a PFC to a sender of packets to the congested queue of destination switch 150. In this example, the sender of packets to the congested queue q2 is shown as host 100-0. In this or other examples, multiple senders of packets to queue q2 can be identified and source switch 110 can send PFC to those multiple senders of packets to queue q2. The PFC can cause a sender network interface device associated with host 100-0 to pause packet transmission from one or more queues in a pool of individually pausable queues can serve flows of the same-TC or priority.

Congestion such as incast congestion may occur in a last hop switch for remote direct memory access (RDMA) flows or other transport protocols. The sender-to-switch signaling delay of SFC can be highest when the congestion point is the last hop switch. In some examples, source switch 110 can receive or intercept SFCs and store congestion information in SFC-to-source tracker 112 such as one or more of: destination IP address, DSCP, or pause duration for a congested queue at destination switch 150. If source switch 110 receives a data packet with a destination IP address in its cache and the pause duration has not expired, source switch 110 can send a PFC to the data source, resulting in shorter signaling delay. For example, if host 100-N sends traffic that is to be stored in congested queue q2 of destination switch 150, source switch 110 can access stored information in SFC-to-source tracker 112 to determine if there is a congested queue and whether traffic to be sent to destination switch 150 are received during a pause duration. Pause information can be stored in one or more first hop switches (or other switches that are not first hop switches) so that any flows to be transmitted to the congestion point or congested queue can be signaled directly from the first hop switch. If traffic to be sent to destination switch 150 are received before a pause duration, source switch 110 can send a PFC to a host 100-N to pause traffic to be sent to the congested queue. In such case, destination switch 150 does not need to send another SFC to trigger source switch to send a PFC to host 100-N. Destination switch 150 can update pause durations for a particular queue in some examples based on changes to congestion levels.

Operations of source switch 110 to detect an SFC, generate a PFC to at least one sender of at least one packet to a congested queue or queues, and perform SFC-to-source tracking to inform at least one packet sender to at least one congested queue to pause or reduce transmission rate can be performed using a programmable packet processing pipeline 114 or other processors, as described herein. Programmable processing pipeline 114 can be programmable by P4, C, Python, Broadcom Network Programming Language (NPL), or x86 compatible executable binaries or other executable binaries.

In some cases, provide sub-round trip time (RTT) detection and response to congestion because providing PFC from source switch 110, instead of an intermediate or destination switch can avoid time taken for network element traversals from destination switch 150. Earlier congestion notification can protect scarce switch buffer resources and push the queueing to sender network interface device buffers. This can mitigate congestions in the network, such as many-to-one incast congestion.

Sender network interface devices associated with one or more of hosts 100-0 to 100-N can determine priority level associated with a PFC as a function of DSCP value and/or destination IP address (endpoint destination) to identify flow priority. Also, source switch 110 can determine a same priority as that of the sender network interface device to determine priority level associated with a PFC as a function of DSCP value and/or destination IP address (endpoint destination) to identify flow priority or SFC signal priority. Based on information in the SFC signal concerning flow priority, a determination can be made of the PFC priority to pause. At hosts 100-0 to 100-N, congestion control (CC) in response to receipt of a PFC, can be implemented either in software or hardware. Sender network interface devices associated with one or more of hosts 100-0 to 100-N can pause flows traversing the congested switch, port, or queue of destination switch 150 after receiving the congestion information in a PFC, while attempting to reduce congestion of any non-congested flows from Head-of-Line (HoL) and avoiding any changes to the application or network operators' quality of service (QoS) infrastructure such as more DSCP code points or rewriting DSCP over the administrator domain boundaries.

One or more of hosts 100-0 to 100-N and/or associated network interface devices may allocate flows sharing a unique congestion point exclusively to one hardware queue, and no other transmit flows are allocated to the queue (e.g., per-destination queue). The allocation can be dynamic and temporal, such that a strict subset of limited number of queues can serve currently active flows that could be subject to congestion or PFC.

E2E congestion control algorithms can be used whereby network interface device-side pausing of packet transmission at one or more of hosts 100-0 to 100-N can migrate packet queueing from a buffer in destination switch 150 to a buffer for network interface device associated with one or more of hosts 100-0 to 100-N, without pausing or queueing at intermediate switch buffers as can be caused by PFC via hop-by-hop backpressure.

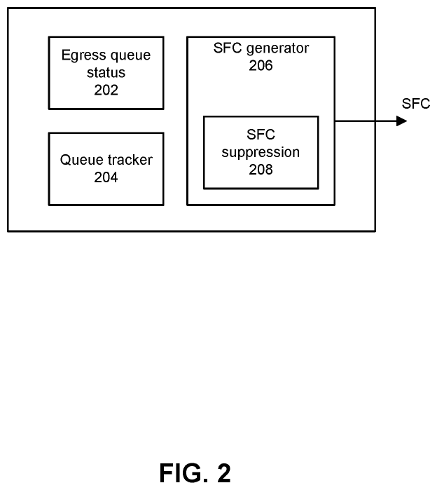

FIG. 2 depicts an example system to identify congestion and generate SFC at a switch. In some examples, the congestion detection can occur at a last hop, destination switch in a datacenter or prior to the last hop, destination switch in a datacenter. For at least one egress port and at least one associated queue, egress queue status 202 can track a depth of the associated queue. Queue tracker 204 can detect an egress queue depth meets or exceeds a threshold and cause generation of an SFC message to be transmitted to a sender network interface device and the SFC message can bypass the congested queue. Probabilistic functions such as Weighted Random Early Detection (WRED) or a Proportional-Integral (PI) controller could be used to detect congestion at a queue.

SFC generator 206 can generate an SFC message. The SFC message can include a pause time duration to drain the congested queue down to a target queue depth. The pause time P can be calculated as P=(C−T)/r+D, where C can represent current egress queue depth, T can represent target queue depth, r can represent the port's line rate and D can represent the delay from the congested switch to the sender. The target queue depth T can be selected to reduce queueing delay at full link utilization. Value D can be approximated as half of base-RTT. RTT can represent (i) a time from a first network interface device sending a packet to a second network interface device to the time the second network interface device receives the packet plus (ii) a time taken for the first network interface device to receive an acknowledgement (ACK) of packet receipt from the second network interface device.

The SFC message can be created by copying a packet in a congested queue and truncating its payload. One or more packets carrying an SFC can include the n-tuple of the original data packet (e.g., source address, destination address, IP protocol, transport layer source port, and destination port) but with its source and destination IP/port pairs swapped for forwarding to the data sender. The per-packet priority can be set to the same value as that of RoCEv2 Congestion Notification Packets (CNPs) to cause the forwarding switches to prioritize the SFC message. The SFC message can identify an exact remote direct memory access (RDMA) connection to pause, by carrying a Queue-Pair (QP) number that, together with the source and destination IP addresses, DSCP value, and transport protocol identifier (ID), can identify an end-to-end connection of the original packet.

When the sender network interface device receives the SFC message, it can pause the RDMA QP connection, queue, or priority queue until the pause-end time, which is the sender network interface device's current time plus the pause duration specified in the SFC message. If the sender network interface device receives another SFC message for a QP number, queue, or priority queue that is currently paused, its pause-end time can be updated with the new pause-end time. Note that examples are not limited to RDMA and can apply to any transport protocol such as TCP.

To prevent or reduce a likelihood that a burst of SFC messages with pause requests from being sent to one or more of the incast senders, SFC suppression 206 can utilize a Bloom-filter indexed by a hash value of source/destination IPs and QP number(s) as well as DSCP value, or transport protocol endpoint identifier, for which the switch has recently generated SFC messages. The filter can be reset periodically (e.g., every half RTT), to ensure that enough SFC messages are generated to the incast senders, keeping their pause times up to date. When a false positive occurs, the impacted flow(s) may experience false suppression over multiple reset cycles. To attempt to avoid false positives, a version number, which changes every cycle, can be applied into the hash input.

Egress queue status 202, queue tracker 204, SFC generator 206, and/or SFC suppression 208 can be implemented using a programmable dataplane circuitry that includes one or more match-action units (MAUs). Configuration of the programmable dataplane circuitry can occur using an application program interface (API), command line interface (CLI), dataplane programming language, or configuration in one or more packets from a control plane, orchestrator, operating system (OS), and/or driver.

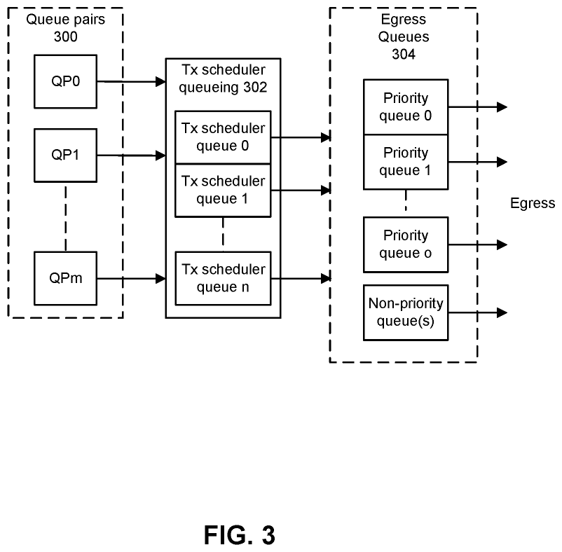

FIG. 3 depicts an example manner of allocating queues for packet egress in a source network interface device. Queue pairs 300 can include multiple queues QP0 to QPm. Queue pairs 300 can be allocated as part of remote direct memory access (RDMA) queue pairs and available for packet transmission or receipt. In other cases, queues pairs 300 can represent transmit and/or receive queues available to threads, applications, services, microservices, or other source, to transmit packets. Transmit (Tx) scheduler 302 can provide for scheduling packets for transmission according to hierarchical quality of service (HQoS) to allocate packets among Tx scheduler queues 0 to n, where n is an integer.

Packets allocated to TX scheduler queues 0 to n can be allocated to egress queues 304 prior to egress. Egress queues 304 can include priority queues 0 to o as well as non-priority queues. Packets can be egressed from ports of a source network interface device according to priority order by allocating more bandwidth to higher priority queues than to lower priority queues. In some cases, under PFC, a number of priority levels are limited to 8. However, egress queues 304 can include a number of priority queues beyond 8, as value o can be 8 or more, as well as non-priority queues. Egress queues 304 could also be implemented as a part of queues of TX scheduler 302.

A priority queue may include packets of multiple flows transmitted to different destinations. A priority level of a queue that is to be paused based on receipt of a PFC can be based on a function of a DSCP value, and/or destination IP address (endpoint destination). For packets with different destinations in a priority queue, where a path to a destination is subject to a PFC but paths to other destinations are not subject to PFC, pausing transmission from a priority queue can result in head of line (HoL) blocking as transmission of some packets are paused even if there no reported congestion along a path to their destination(s). A source network interface device can reallocate one or more flows that are not subject to PFC but share a queue with a flow that is subject to PFC to another priority or non-priority queue or queues to attempt to avoid a pause of transmission of packets of one or more flows that are not subject to PFC.

A packet may be used herein to refer to various formatted collections of bits that may be sent across a network, such as Ethernet frames, IP packets, Transmission Control Protocol (TCP) segments, UDP datagrams, etc. Also, as used in this document, references to L2, L3, L4, and L7 layers (layer 2, layer 3, layer 4, and layer 7) are references respectively to the second data link layer, the third network layer, the fourth transport layer, and the seventh application layer of the OSI (Open System Interconnection) layer model.

A flow can be a sequence of packets being transferred between two endpoints, generally representing a single session using a known protocol. Accordingly, a flow can be identified by a set of defined tuples and, for routing purpose, a flow is identified by the two tuples that identify the endpoints, i.e., the source and destination addresses. For content-based services (e.g., load balancer, firewall, Intrusion detection system etc.), flows can be identified at a finer granularity by using N-tuples (e.g., source address, destination address, IP protocol, transport layer source port, and destination port). A packet in a flow is expected to have the same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier.

For multiple RDMA traffic classes, flows can be spread over multiple queues to reduce a chance of HoL blocking of a flow that is not subject to PFC but share a queue with a flow that is subject to PFC because fewer flows share a queue. In other words, RDMA traffic of a single traffic class (TC) can be allocated to multiple priority queues (e.g., egress queues 304). Both the sender network interface device and the source switch can define a list of PFC priorities that will be used by a single TC. Flows of a TC can be load-balanced to the multiple queues as a function of DSCP value, and/or destination IP address (endpoint destination) to identify flow priority.

At least one processor and/or packet processing pipeline of a sender network interface device can control QP flow to connection mapping 116 with a priority queue. For example, assume two TCs for TCP and three TCs for RDMA. One of the RDMA TC can be identified as subject to incast communication pattern, based on receipt of a PFC. Out of 8 PFC priority queues, 4 of the priority queues can be allocated to serve traffic that could be subject to PFC and the other 4 queues can be used to serve the other 4 TCs (two TCP, two RDMA). In some configurations, TCs not subject to PFC can be assigned into one PFC queue and the remaining 7 PFC queues can serve flows can that be subject to PFC. In some configurations, TCs not subject to pausing by PFCs can be assigned into one or more of egress queues 304, and the remaining egress queues 304 can serve flows that are subject to pausing by PFCs. In some cases, PFC queues of egress queues 304 may or may not be subject to priority scheduling or any other QoS. In other words, PFC priority can be decoupled from the scheduling and QoS priority and use the PFC priority for controlling which PFC queues of egress queues 304 to pause/resume.

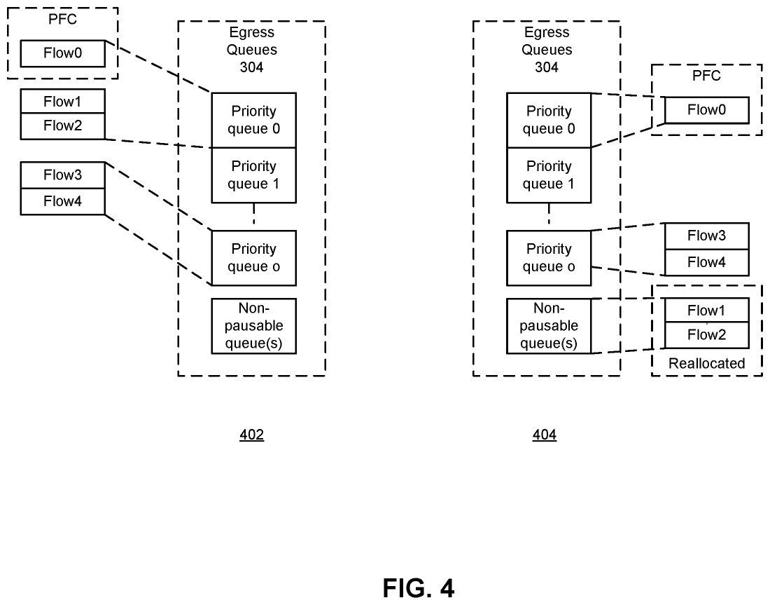

FIG. 4 depicts an example of reallocation of flows. One or more of priority queues 0 to o can be a PFC-enabled queue or a PFC-disabled queue. For example, receipt of a PFC frame associated with a PFC-enabled queue can cause exertion of a pause for packets associated with the PFC-enabled queue. For example, receipt of a PFC frame associated with a PFC-disabled queue may not cause pause of transmission of packets from the PFC-disabled queue. However, both a PFC-enabled queue and a PFC-disabled queue can reduce the transmission rate or increase the transmission rate based on quality of service (QoS) configurations. In some examples, depending on an applicable configuration, priority level queues can be PFC-enabled or subject to pause or reduced rate of transmission or not subject to pause or reduced rate of transmission. In some examples, some queues, such as non-priority queues are not subject to pause and can be PFC-disabled.

After a PFC is received, such as from a source (first hop) switch in a data center, the network interface device and/or its host computing system determines that flow 0 is subject to PFC. Scenario 402 shows packets of flow 0 are allocated to priority queue 0 and packets of flows 1 and 2 are also allocated to priority queue 0. In this example, priority queue 0 is a PFC-enabled queue and is able to be paused by being subject to PFC, pausing, or other congestion control. Based on flow 0 being subject to a pause or reduced rate of transmission but flows 1 and 2 are not subject to a pause or reduced rate of transmission, as shown in scenario 404, packets of flows 1 and 2 can be migrated or associated with non-pausable queue(s) (PFC-disabled queue(s)). In this example, transmission of packets from non-pausable queue(s) are not paused despite a PFC requesting pause of transmission of packets from such queue(s).

In some examples, the mapping from a flow to a queue is decided at the beginning of a flow setup and is not modified after packet transmission in a flow starts.

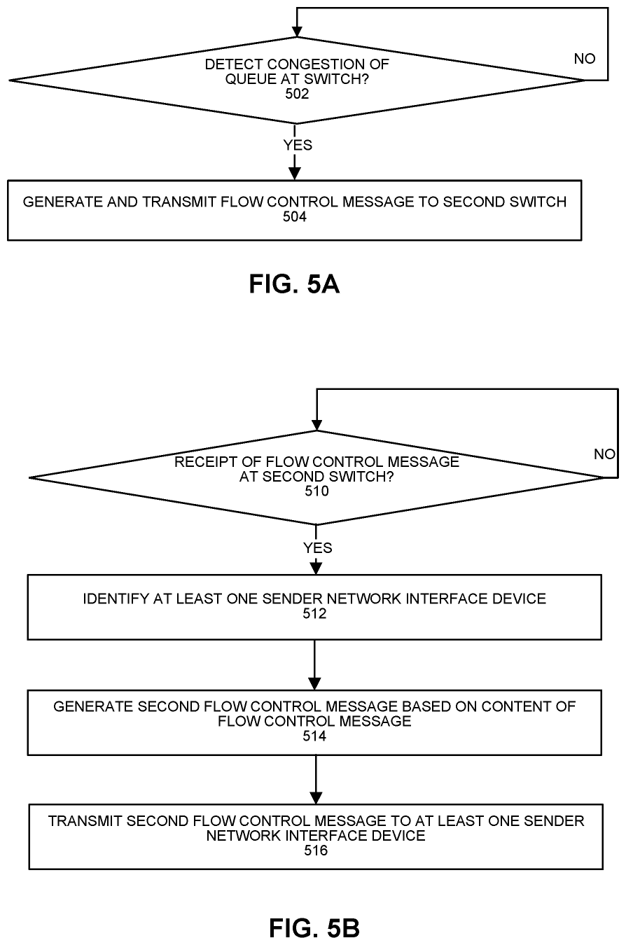

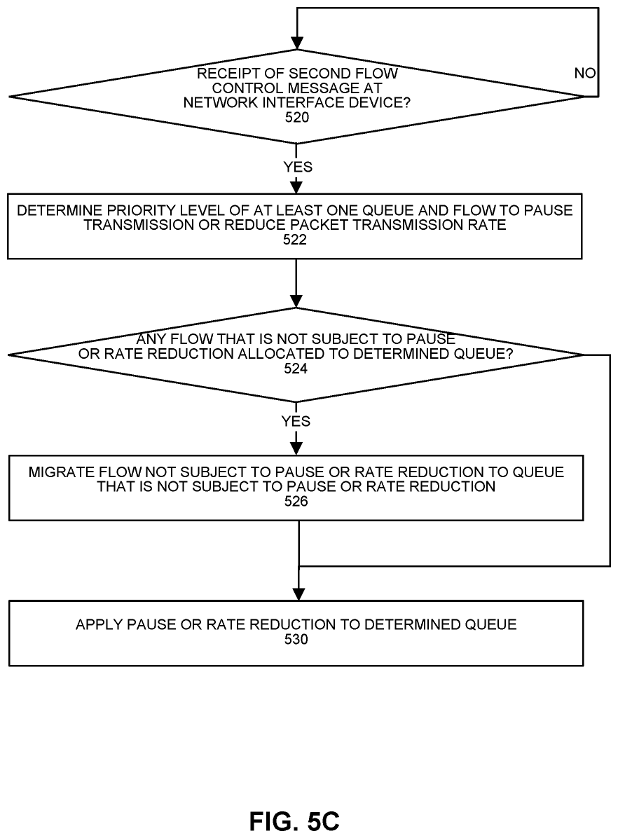

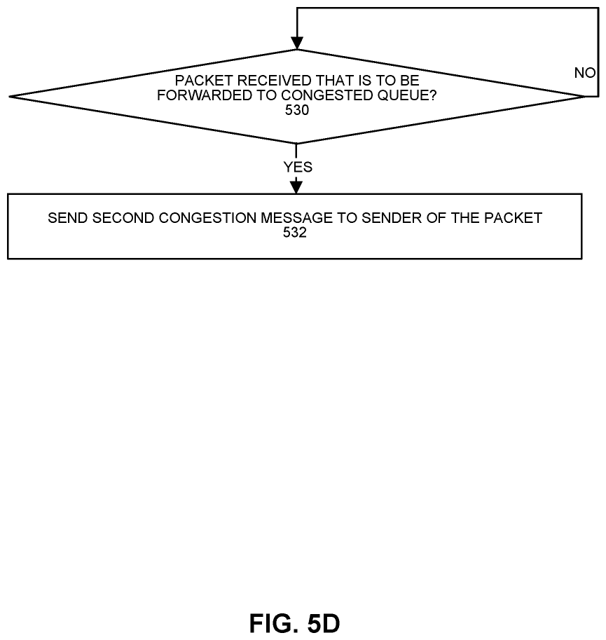

FIG. 5A depicts an example process. The process can be performed by a host system, network interface device, and/or a switch. At 502, a determination can be made, at a switch as to whether a queue is congested. The switch can be a last hop switch in a data center, wide area network, or local area network and provide packets to a destination endpoint network interface device. At 504, based on identification of a congested queue, the switch can generate and transmit a flow control message to a second switch. The flow control message can include one or more of: IP address of sender network interface device, IP address of congested switch, IP address of destination network interface device, Differentiated Services Code Point (DSCP) (e.g., identifier of congested queue), pause time (to be applied against a reference start time), or remote direct memory access (RDMA) queue pair (QP) number. In some examples, the flow control message can be conveyed using L3 (e.g., IP) protocol communications to permit multiple hop forwarding of the flow control message to the second switch.

FIG. 5B depicts an example process. The process can be performed by a host system, network interface device, and/or a switch. At 510, a determination can be made, at the second switch, as to whether a flow control message has been received. At 512, based on a determination that the second switch received a flow control message, the second switch can identify at least one sender of packets to the congested queue. A determination of sender network interface device can be made based on a mapping of destination queue-to-sender network interface device.

At 514, the second switch can generate a second flow control message based on content of the flow control message. The second flow control message can include a PFC. The second flow control message can include one or more of: sender queue priority level, pause duration (converted according to line speed), or remote direct memory access (RDMA) queue pair (QP) number. At 516, the second switch can transmit the second flow control message to at least one sender network interface device. The second flow control message can be sent using an Ethernet packet in some examples as a PFC.

FIG. 5C depicts an example process. The process can be performed by a host system, network interface device, and/or a switch. At 520, a determination can be made, at a network interface device, as to whether a second flow control message has been received. The second flow control message can include a PFC. At 522, based on a determination that the second flow control message has been received, the network interface device can determine a priority level of a queue and flow that is to be paused or have its transmit rate reduced. The priority level and flow can be based on a function of a DSCP value and/or destination IP address (endpoint destination). At 524, a determination can be made if the determined queue is allocated to one or more flows that are not subject to pause or transmit rate reduction. At 526, based on a determination that the determined queue is allocated to one or more flows that are not subject to pause or transmit rate reduction, the one or more flows that are not subject to pause or transmit rate reduction can be associated with a queue that is not subject to pause or transmit rate reduction. At 530, pause or transmit rate reduction can be applied to the determined queue for the pause time specified in the second flow control message. If the second flow control message includes a transmit rate reduction amount or percentage, the transmit rate from the determined queue can be adjusted according to such transmit rate reduction amount or percentage.

FIG. 5D depicts an example process. The process can be performed by a host system, network interface device, and/or a switch. At 530, a determination can be made, at the second switch, as to whether a packet is received that is to be forwarded to a congested queue. The second switch can store identifiers and mappings of congested queues, pause durations, and sender devices. At 532, a packet is received that is to be forwarded to a congested queue, the second switch can send a second flow control message to a sender of the packet that is to be forwarded to a congested queue to cause the sender of the packet to pause packet transmission or reduce transmit rate. Note that queues subject to pause can be unpaused.

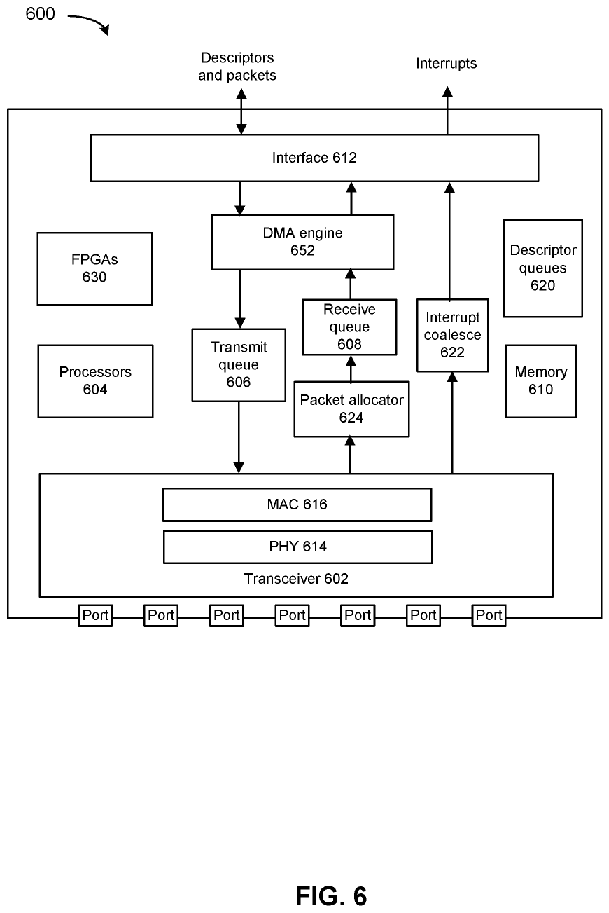

FIG. 6 depicts a network interface. Various processor resources in the network interface can detect an SFC, generate a PFC to at least one sender of at least one packet to a congested queue or queues, and perform SFC-to-source tracking to inform at least one packet sender to at least one congested queue to pause or reduce transmission rate, as described herein. In some examples, network interface 600 can be implemented as a network interface controller, network interface card, network device, network interface device, a host fabric interface (HFI), or host bus adapter (HBA), and such examples can be interchangeable. Network interface 600 can be coupled to one or more servers using a bus, PCIe, CXL, or DDR. Network interface 600 may be embodied as part of a system-on-a-chip (SoC) that includes one or more processors, or included on a multichip package that also contains one or more processors.

Some examples of network device 600 are part of an Infrastructure Processing Unit (IPU) or data processing unit (DPU) or utilized by an IPU or DPU. An xPU can refer at least to an IPU, DPU, graphics processing unit (GPU), general purpose GPU (GPGPU), or other processing units (e.g., accelerator devices). An IPU or DPU can include a network interface with one or more programmable pipelines or fixed function processors to perform offload of operations that could have been performed by a central processing unit (CPU). The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 600 can include transceiver 602, processors 604, transmit queue 606, receive queue 608, memory 610, and bus interface 612, and DMA engine 652. Transceiver 602 can be capable of receiving and transmitting packets in conformance with the applicable protocols such as Ethernet as described in IEEE 802.3, although other protocols may be used. Transceiver 602 can receive and transmit packets from and to a network via a network medium (not depicted). Transceiver 602 can include PHY circuitry 614 and media access control (MAC) circuitry 616. PHY circuitry 614 can include encoding and decoding circuitry (not shown) to encode and decode data packets according to applicable physical layer specifications or standards. MAC circuitry 616 can be configured to perform MAC address filtering on received packets, process MAC headers of received packets by verifying data integrity, remove preambles and padding, and provide packet content for processing by higher layers. MAC circuitry 616 can be configured to assemble data to be transmitted into packets, that include destination and source addresses along with network control information and error detection hash values.

Processors 604 can be any a combination of a: processor, core, graphics processing unit (GPU), field programmable gate array (FPGA), application specific integrated circuit (ASIC), or other programmable hardware device that allow programming of network interface 600. For example, a “smart network interface” or SmartNIC can provide packet processing capabilities in the network interface using processors 604. Processors 604 can include a programmable processing pipeline that is programmable using any programming language or executable binaries. A programmable processing pipeline can include one or more match-action units (MAUs) that can detect an SFC and generate a PFC to a sender as well as perform SFC-to-source tracking to message packet senders to a congested queue to pause or reduce transmission rate, as described herein. Processors, FPGAs, other specialized processors, controllers, devices, and/or circuits can be used utilized for packet processing or packet generation. Ternary content-addressable memory (TCAM) can be used for parallel match-action or look-up operations on packet header content.

Packet allocator 624 can provide distribution of received packets for processing by multiple CPUs or cores using timeslot allocation described herein or receive side scaling (RSS). When packet allocator 624 uses RSS, packet allocator 624 can calculate a hash or make another determination based on contents of a received packet to determine which CPU or core is to process a packet.

Interrupt coalesce 622 can perform interrupt moderation whereby network interface interrupt coalesce 622 waits for multiple packets to arrive, or for a time-out to expire, before generating an interrupt to host system to process received packet(s). Receive Segment Coalescing (RSC) can be performed by network interface 600 whereby portions of incoming packets are combined into segments of a packet. Network interface 600 provides this coalesced packet to an application.

Direct memory access (DMA) engine 652 can copy a packet header, packet payload, and/or descriptor directly from host memory to the network interface or vice versa, instead of copying the packet to an intermediate buffer at the host and then using another copy operation from the intermediate buffer to the destination buffer.

Memory 610 can be any type of volatile or non-volatile memory device and can store any queue or instructions used to program network interface 600. Transmit queue 606 can include data or references to data for transmission by network interface. Receive queue 608 can include data or references to data that was received by network interface from a network. Descriptor queues 620 can include descriptors that reference data or packets in transmit queue 606 or receive queue 608. Bus interface 612 can provide an interface with host device (not depicted). For example, bus interface 612 can be compatible with PCI, PCI Express, PCI-x, Serial ATA, and/or USB compatible interface (although other interconnection standards may be used).

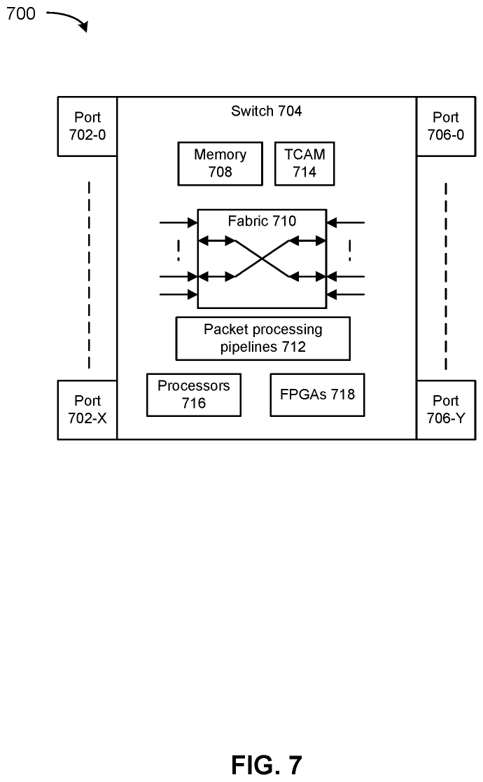

FIG. 7 depicts an example switch. Various resources in the switch (e.g., packet processing pipelines 712, processors 716, and/or FPGAs 718) can be configured to generate a pause message based on receipt of an SFC as described herein. Switch 704 can route packets or frames of any format or in accordance with any specification from any port 702-0 to 702-X to any of ports 706-0 to 706-Y (or vice versa). Any of ports 702-0 to 702-X can be connected to a network of one or more interconnected devices. Similarly, any of ports 706-0 to 706-X can be connected to a network of one or more interconnected devices.

In some examples, switch fabric 710 can provide routing of packets from one or more ingress ports for processing prior to egress from switch 704. Switch fabric 70 can be implemented as one or more multi-hop topologies, where example topologies include torus, butterflies, buffered multi-stage, etc., or shared memory switch fabric (SMSF), among other implementations. SMSF can be any switch fabric connected to ingress ports and all egress ports in the switch, where ingress subsystems write (store) packet segments into the fabric's memory, while the egress subsystems read (fetch) packet segments from the fabric's memory.

Memory 708 can be configured to store packets received at ports prior to egress from one or more ports. Packet processing pipelines 712 can determine which port to transfer packets or frames to using a table that maps packet characteristics with an associated output port. Packet processing pipelines 712 can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines 712 can implement access control list (ACL) or packet drops due to queue overflow. Packet processing pipelines 712 can be configured to add operation and telemetry data concerning switch 704 to a packet prior to its egress.

Configuration of operation of packet processing pipelines 712, including its data plane, can be programmed using P4, C, Python, Broadcom Network Programming Language (NPL), or x86 compatible executable binaries or other executable binaries. Processors 716 and FPGAs 718 can be utilized for packet processing.

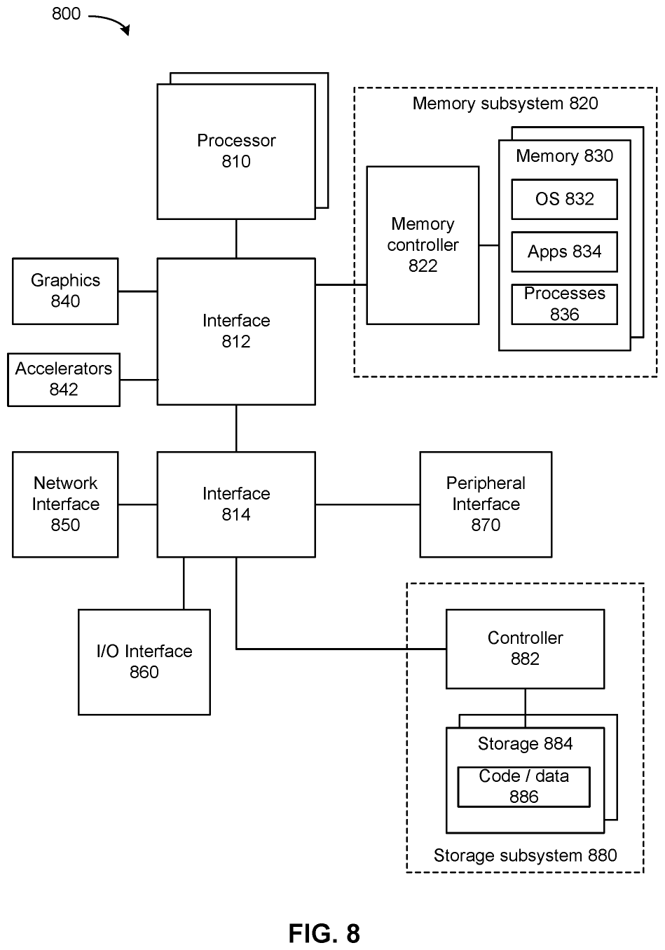

FIG. 8 depicts an example computing system. Various embodiments can use components of system 800 (e.g., processor 810, network interface 850, and so forth) to detect an SFC, generate a PFC to at least one sender of one or more packets to a congested queue, as well as perform SFC-to-source tracking to proactively inform packet senders to a congested queue to pause or reduce transmission rate, as described herein. System 800 includes processor 810, which provides processing, operation management, and execution of instructions for system 800. Processor 810 can include any type of microprocessor, central processing unit (CPU), graphics processing unit (GPU), processing core, or other processing hardware to provide processing for system 800, or a combination of processors. Processor 810 controls the overall operation of system 800, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 800 includes interface 812 coupled to processor 810, which can represent a higher speed interface or a high throughput interface for system components that needs higher bandwidth connections, such as memory subsystem 820 or graphics interface components 840, or accelerators 842. Interface 812 represents an interface circuit, which can be a standalone component or integrated onto a processor die. Where present, graphics interface 840 interfaces to graphics components for providing a visual display to a user of system 800. In one example, graphics interface 840 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 840 generates a display based on data stored in memory 830 or based on operations executed by processor 810 or both. In one example, graphics interface 840 generates a display based on data stored in memory 830 or based on operations executed by processor 810 or both.

Accelerators 842 can be a fixed function or programmable offload engine that can be accessed or used by a processor 810. For example, an accelerator among accelerators 842 can provide compression (DC) capability, cryptography services such as public key encryption (PKE), cipher, hash/authentication capabilities, decryption, or other capabilities or services. In some embodiments, in addition or alternatively, an accelerator among accelerators 842 provides field select controller capabilities as described herein. In some cases, accelerators 842 can be integrated into a CPU socket (e.g., a connector to a motherboard or circuit board that includes a CPU and provides an electrical interface with the CPU). For example, accelerators 842 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 842 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 820 represents the main memory of system 800 and provides storage for code to be executed by processor 810, or data values to be used in executing a routine. Memory subsystem 820 can include one or more memory devices 830 such as read-only memory (ROM), flash memory, one or more varieties of random access memory (RAM) such as DRAM, or other memory devices, or a combination of such devices. Memory 830 stores and hosts, among other things, operating system (OS) 832 to provide a software platform for execution of instructions in system 800. Additionally, applications 834 can execute on the software platform of OS 832 from memory 830. Applications 834 represent programs that have their own operational logic to perform execution of one or more functions. Processes 836 represent agents or routines that provide auxiliary functions to OS 832 or one or more applications 834 or a combination. OS 832, applications 834, and processes 836 provide software logic to provide functions for system 800. In one example, memory subsystem 820 includes memory controller 822, which is a memory controller to generate and issue commands to memory 830. It will be understood that memory controller 822 could be a physical part of processor 810 or a physical part of interface 812. For example, memory controller 822 can be an integrated memory controller, integrated onto a circuit with processor 810.

In some examples, OS 832 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others. In some examples, a driver can configure network interface 850 to using an API, CLI, dataplane programming language, or configuration in one or more packets from a control plane, orchestrator, OS, and/or driver.

While not specifically illustrated, it will be understood that system 800 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 800 includes interface 814, which can be coupled to interface 812. In one example, interface 814 represents an interface circuit, which can include standalone components and integrated circuitry. In one example, multiple user interface components or peripheral components, or both, couple to interface 814. Network interface 850 provides system 800 the ability to communicate with remote devices (e.g., servers or other computing devices) over one or more networks. Network interface 850 can include an Ethernet adapter, wireless interconnection components, cellular network interconnection components, USB (universal serial bus), or other wired or wireless standards-based or proprietary interfaces. Network interface 850 can transmit data to a device that is in the same data center or rack or a remote device, which can include sending data stored in memory. Network interface 850 can receive data from a remote device, which can include storing received data into memory.

In one example, system 800 includes one or more input/output (I/O) interface(s) 860. I/O interface 860 can include one or more interface components through which a user interacts with system 800 (e.g., audio, alphanumeric, tactile/touch, or other interfacing). Peripheral interface 870 can include any hardware interface not specifically mentioned above. Peripherals refer generally to devices that connect dependently to system 800. A dependent connection is one where system 800 provides the software platform or hardware platform or both on which operation executes, and with which a user interacts.

In one example, system 800 includes storage subsystem 880 to store data in a nonvolatile manner. In one example, in certain system implementations, at least certain components of storage 880 can overlap with components of memory subsystem 820. Storage subsystem 880 includes storage device(s) 884, which can be or include any conventional medium for storing large amounts of data in a nonvolatile manner, such as one or more magnetic, solid state, or optical based disks, or a combination. Storage 884 holds code or instructions and data 886 in a persistent state (e.g., the value is retained despite interruption of power to system 800). Storage 884 can be generically considered to be a “memory,” although memory 830 is typically the executing or operating memory to provide instructions to processor 810. Whereas storage 884 is nonvolatile, memory 830 can include volatile memory (e.g., the value or state of the data is indeterminate if power is interrupted to system 800). In one example, storage subsystem 880 includes controller 882 to interface with storage 884. In one example controller 882 is a physical part of interface 814 or processor 810 or can include circuits or logic in both processor 810 and interface 814.

A volatile memory is memory whose state (and therefore the data stored in it) is indeterminate if power is interrupted to the device. Dynamic volatile memory uses refreshing the data stored in the device to maintain state. One example of dynamic volatile memory incudes DRAM (Dynamic Random Access Memory), or some variant such as Synchronous DRAM (SDRAM). An example of a volatile memory include a cache. A memory subsystem as described herein may be compatible with a number of memory technologies, such as DDR3 (Double Data Rate version 3, original release by JEDEC (Joint Electronic Device Engineering Council) on Jun. 16, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of one or more of the above, or other memory.

A power source (not depicted) provides power to the components of system 800. More specifically, power source typically interfaces to one or multiple power supplies in system 800 to provide power to the components of system 800. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 800 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (COX), 3GPP Long Term Evolution (LTE) (4G), 3GPP 5G, a service mesh, and variations thereof. Data can be copied or stored to virtualized storage nodes or accessed using a protocol such as NVMe over Fabrics (NVMe-oF) or NVMe.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

An example includes one or more examples and includes a method comprising: at a network interface controller (NIC): receiving PFC from a first hop switch that sends SFC on behalf of another congested switch; for traffic subject to PFC, if not all priority queues are used for PFC, allocate traffic across available priority queues not subject to PFC prior to transmission.

An example includes one or more examples, wherein the first hop switch comprises a top of rack (ToR) switch and the another switch comprises a ToR switch.

An example includes one or more examples, wherein the SFC comprises a destination IP address, Differentiated Services Code Point (DSCP), pause time for congested queue.

Example 1 includes an apparatus comprising a switch comprising circuitry, when operational, to: receive a message identifying congestion in a second switch; drop the message; generate a pause frame; and cause transmission of the pause frame to at least one sender of packets to a congested queue in the second switch.

Example 2 includes one or more examples, wherein the message comprises one or more of: a destination IP address, Differentiated Services Code Point (DSCP) value, or pause duration for the congested queue.

Example 3 includes one or more examples, wherein the DSCP value is to identify a traffic class of the congested queue.

Example 4 includes one or more examples, wherein the pause frame is consistent with Priority Flow Control (PFC) of IEEE 802.1Qbb (2011).

Example 5 includes one or more examples, wherein the circuitry, when operational, is to: store, from the message identifying congestion in the second switch, congestion information associated with the congested queue comprising one or more of: destination internet protocol (IP) address, Differentiated Services Code Point (DSCP) value, or pause end time of the congested queue.

Example 6 includes one or more examples, wherein the circuitry, when operational, is to: based on receipt of one or more packets from a second sender at the switch: access stored congestion information and based on at least one received packet from the second sender to be transmitted to the congested queue in the second switch, cause transmission of a second pause frame to the second sender.

Example 7 includes one or more examples, wherein the switch comprises a source top of rack switch and the second switch includes the congested queue.

Example 8 includes one or more examples, wherein the circuitry comprises a programmable dataplane circuitry comprising one or more match-action units.

Example 9 includes one or more examples, wherein the switch further comprises: a switch fabric; one or more ingress ports; and one or more egress ports.

Example 10 includes one or more examples, and includes a method comprising: at a first hop switch in a data center network: receiving a message identifying congestion in a second switch; dropping the message; generating a pause frame; and causing transmission of the pause frame to at least one sender of packets to a congested queue in the second switch.

Example 11 includes one or more examples, wherein the message comprises one or more of: a destination IP address, Differentiated Services Code Point (DSCP) value, or pause duration for the congested queue.

Example 12 includes one or more examples, wherein the DSCP value identifies a traffic class of the congested queue.

Example 13 includes one or more examples, and includes: at the first hop switch: storing, from the message identifying congestion in the second switch, congestion information associated with the congested queue comprising one or more of: destination internet protocol (IP) address, Differentiated Services Code Point (DSCP) value, or pause end time of the congested queue.

Example 14 includes one or more examples, and includes based on receipt of one or more packets from a second sender at the first hop switch in the data center network: accessing stored congestion information and based on at least one received packet from the second sender to be transmitted to the congested queue in the second switch, cause transmission of a second pause frame to the second sender.

Example 15 includes one or more examples, wherein the first hop switch comprises a source top of rack switch and the second switch comprises the congested queue.

Example 16 includes one or more examples, and includes a computer-readable medium comprising instructions that if executed, by one or more processors, cause:

configuration of a switch to: based on receipt of a message identifying congestion in a second switch, drop the message; generate a pause frame; and cause transmission of the pause frame to at least one sender of packets to a congested queue in the second switch.

Example 17 includes one or more examples, wherein the message comprises one or more of: a destination IP address, Differentiated Services Code Point (DSCP) value, or pause duration for the congested queue.

Example 18 includes one or more examples, wherein the DSCP value is to identify a traffic class of the congested queue.

Example 19 includes one or more examples, and includes instructions that if executed, by one or more processors, cause: configuration of the switch to: store, from the message identifying congestion in the second switch, congestion information associated with the congested queue comprising one or more of: destination internet protocol (IP) address, Differentiated Services Code Point (DSCP) value, or pause end time of the congested queue.

Example 20 includes one or more examples, and includes instructions that if executed, by one or more processors, cause: configuration of the switch to: access stored congestion information and based on at least one received packet from a second sender to be transmitted to the congested queue in the second switch, cause transmission of a second pause frame to the second sender.

Example 21 includes one or more examples, wherein the switch comprises one or more of: network interface controller (NIC), SmartNIC, router, switch, forwarding element, infrastructure processing unit (IPU), or data processing unit (DPU).

What is claimed is:

1. An apparatus comprising
a switch comprising circuitry, when operational, to:
receive a message identifying congestion in a second switch;
drop the message;
generate a pause frame; and
cause transmission of the pause frame to at least one sender of packets to a congested queue in the second switch.

2. The apparatus of claim 1, wherein the message comprises one or more of: a destination IP address, Differentiated Services Code Point (DSCP) value, or pause duration for the congested queue.

3. The apparatus of claim 2, wherein the DSCP value is to identify a traffic class of the congested queue.

4. The apparatus of claim 1, wherein the pause frame is consistent with Priority Flow Control (PFC) of IEEE 802.1Qbb (2011).

5. The apparatus of claim 1, wherein the circuitry, when operational, is to:
store, from the message identifying congestion in the second switch, congestion information associated with the congested queue comprising one or more of: destination internet protocol (IP) address, Differentiated Services Code Point (DSCP) value, or pause end time of the congested queue.

6. The apparatus of claim 5, wherein the circuitry, when operational, is to:
based on receipt of one or more packets from a second sender at the switch:
access stored congestion information and
based on at least one received packet from the second sender to be transmitted to the congested queue in the second switch, cause transmission of a second pause frame to the second sender.

7. The apparatus of claim 1, wherein
the switch comprises a source top of rack switch and
the second switch includes the congested queue.

8. The apparatus of claim 1, wherein
the circuitry comprises a programmable dataplane circuitry comprising one or more match-action units.

9. The apparatus of claim 8, wherein the switch further comprises:
a switch fabric;
one or more ingress ports; and
one or more egress ports.

10. A method comprising:
at a first hop switch in a data center network:
receiving a message identifying congestion in a second switch;
dropping the message;
generating a pause frame; and
causing transmission of the pause frame to at least one sender of packets to a congested queue in the second switch.

11. The method of claim 10, wherein the message comprises one or more of: a destination IP address, Differentiated Services Code Point (DSCP) value, or pause duration for the congested queue.

12. The method of claim 11, wherein the DSCP value identifies a traffic class of the congested queue.

13. The method of claim 10, comprising:
at the first hop switch:
storing, from the message identifying congestion in the second switch, congestion information associated with the congested queue comprising one or more of: destination internet protocol (IP) address, Differentiated Services Code Point (DSCP) value, or pause end time of the congested queue.

14. The method of claim 13, comprising:
based on receipt of one or more packets from a second sender at the first hop switch in the data center network:
accessing stored congestion information and
based on at least one received packet from the second sender to be transmitted to the congested queue in the second switch, cause transmission of a second pause frame to the second sender.

15. The method of claim 10, wherein
the first hop switch comprises a source top of rack switch and
the second switch comprises the congested queue.

16. A computer-readable medium comprising instructions that if executed, by one or more processors, cause:
configuration of a switch to:
based on receipt of a message identifying congestion in a second switch, drop the message;
generate a pause frame; and
cause transmission of the pause frame to at least one sender of packets to a congested queue in the second switch.

17. The computer-readable medium of claim 16, wherein the message comprises one or more of: a destination IP address, Differentiated Services Code Point (DSCP) value, or pause duration for the congested queue.

18. The computer-readable medium of claim 17, wherein the DSCP value is to identify a traffic class of the congested queue.

19. The computer-readable medium of claim 16, comprising instructions that if executed, by one or more processors, cause:
configuration of the switch to:
store, from the message identifying congestion in the second switch, congestion information associated with the congested queue comprising one or more of: destination internet protocol (IP) address, Differentiated Services Code Point (DSCP) value, or pause end time of the congested queue.

20. The computer-readable medium of claim 19, comprising instructions that if executed, by one or more processors, cause:
configuration of the switch to:
access stored congestion information and
based on at least one received packet from a second sender to be transmitted to the congested queue in the second switch, cause transmission of a second pause frame to the second sender.

21. The computer-readable medium of claim 16, wherein the switch comprises one or more of: network interface controller (NIC), SmartNIC, router, switch, forwarding element, infrastructure processing unit (IPU), or data processing unit (DPU).
